(19) United States
(12) Patent Application Publication
(10) Pub. No.: US 2005/0156839 A1
(43) Pub. Date: Jul. 21, 2005

(54) Field sequential display device and methods of fabricating same

(76) Inventor: Homer L Webb, Austin, TX (US)

Correspondence Address: Winstead Sechrest & Minick, PO Box 50784, Dallas, TX, 75201, US

(21) Appl. No.: 10/517,503

(22) PCT Filed: Jun. 13, 2003
(86) PCT No.: PCT/US03/18762

Related U.S. Application Data
(60) Provisional application No. 60/338,237, filed on Nov. 2, 2001.
(60) Provisional application No. 60/443,053, filed on Jan. 28, 2003.
(60) Provisional application No. 60/446,304, filed on Feb. 10, 2003.

(51) Int. Cl. G09G 3/36

(52) U.S. Cl. 345/87

(57) ABSTRACT

A device adapted for use in a field sequential color display. The device may include first and second polarizers. A light scattering material may be disposed between the first and second polarizers. Additionally, the display may include a light source having a plurality of colors. Portions of the light scattering material are operable for selectable excitation. An excitation of a portion of the light scattering material is operable for controlling an amount of light of a color of the plurality of colors emitted by the display device. Further, sub-frames from which an image frame is composed may be addressed in a segmented fashion, whereby each sub-frame includes a plurality of segments. The light source is correspondingly pulsed in a segmented fashion. A given segment may be illuminated in a different color in each sub-frame. In this way, perceived flicker may be reduced.

### CROSS-REFERENCE TO RELATED APPLICATION

This application claims priority from U.S. provisional application Ser. Nos. 60/388,237 (filed Jun. 13, 2002), 60/443,053 (filed Jan. 28, 2003) and 60/446,304 (filed Feb. 10, 2003), which applications are incorporated herein by reference.

### TECHNICAL FIELD

The present invention relates to the field of flat panel displays, and more particularly to a flat panel display comprising cells that include light scattering material between a light source and a viewing surface enabling a field sequential color display.

### BACKGROUND INFORMATION

In order to minimize the space required by display devices, research into the development of various flat panel display devices such as liquid crystal displays (LCDs), plasma display panels (PDP) and electro-luminescence displays (EL), has been undertaken to displace larger cathode-ray tube displays (CRT) as the most commonly used display devices. Particularly, in the case of LCD devices, liquid crystal technology has been explored because the optical characteristics of liquid crystal material can be controlled in response to changes in electric fields applied thereto. As will be understood by those skilled in the art, a thin film transistor liquid crystal display (TFT-LCD) device typically uses a thin film transistor as a switching device and the electrical-optical effect of liquid crystal molecules to display data visually.

FIG. 1 illustrates a profile view of a cell or pixel 100 of a TFT-LCD device. Cell 100 may comprise two outer layers consisting of polarizers 101, 102, substrates 103, 104 composed of glass, indium tin oxide (ITO) coatings 105, 106, a rubbed polymeric alignment layer 107, 108, electro-optical liquid crystal twisted nematic (TN) material 109, active element TFT transistor 110, metal select and data electrodes 11, 112, color filter 113, light guide 114, and back light 115. The cell gap is the space between 107 and 108. This gap is invaded by elements 111, 112, and 110, which constrain the gap dimensions of the electro-optical material 109.

The structure illustrated in FIG. 1 exhibits several problems. Firstly, active device 10 requires an expensive semiconductor process. Secondarily, active devices 110 may reside inside substrates 107, 108 which limit the cell gap. Thirdly, the drive electrodes 111, 112 may be patterned onto the surface of the ITO coating 106 which is coated onto substrate 104. In order to keep the gap profile small, the thickness of electrodes 111,112 and transistor 110 may be made thin. Further, in order to reduce the resistance, the width of electrodes 111,112 may be increased. A consequence of thin and wide electrodes 111, 112 and a thin transistor 110 may be a reduction in the aspect ratio of cell 100 as well as a limitation in the dimension of the display. Further, the manufacturing requires a multiplicity of carefully controlled steps. For example, the electro-optical effect of the liquid crystal molecule requires careful alignment of the molecules, necessitating expensive preparation of rubbing polymer layers 107 and 108.

Additionally, field sequential color (FSC) systems have been employed in direct view and projection modes based on reflective scattering LCDS, however liquid crystal dispersion systems such as polymer dispersed liquid crystal (PDLC), have not been developed for transmissive FSC presumably due to the perceived lack of optical contrast with such systems. The primary advantage of PDLC is reportedly the lack of a need for polarizers; thus, uses of PDLC in display applications focuses on the reflective scattering mode—direct view and projection—without the use of polarizer films.

The transmissive LCD-based approaches to FSC include ferroelectric (U.S. Pub. No. 2001/0035852), optically controlled birefringence (OCB) or pi-cell (U.S. Pat. No. 4,582,396, and U.S. Pub. No. 2002/0140888, U.S. Pub. No. 2002/0145579, and U.S. Pub. No. 2002/0149551; and U.S. Pub. No. 20020149576 of Yukio et al.), and modified drive techniques applied to TN displays (as reported by Hunet and Bright Lab Co, of Japan, U.S. Pat. No. 6,424,329 and U.S. Pub. No. 2001/0052885). Each of these approaches have their own benefits but also problems with respect to production or cost-performance vis a vis incumbent color LCDs.

Therefore, there is a need in the art for flat panel displays to comprise cells with fewer elements which are made with fewer processing steps thereby reducing the cost of the display.

### SUMMARY

The problems outlined above are addressed by the present invention. Accordingly, there is provided in one embodiment a display device having first and second polarizers. A light scattering material is disposed between the first and second polarizers. Additionally, the display includes a light source having a plurality of colors. Portions of the light scattering material are operable for selectable excitation. An excitation of a portion of the light scattering material is operable for controlling an amount of light of a color of the plurality of colors emitted by the display device.

The foregoing has outlined rather generally the features and technical advantages of one or more embodiments of the present invention in order that the detailed description of the invention that follows may be better understood Additional features and advantages of the invention will be described hereinafter which may form the subject of the claims of the invention.

### BRIEF DESCRIPTION OF THE DRAWINGS

A better understanding of the present invention can be obtained when the following detailed description is considered in conjunction with the following drawings, in which:

FIG. 1 illustrates a profile view of a TFT LCD display device;

FIG. 2 illustrates a light scattering display cell in accordance with an embodiment of the present invention;

FIG. 3 illustrates a cell similar in figuration to the cell of FIG. 2 including dry circuitry associated therewith;

FIG. 4 illustrates an embodiment of a cell for use in a reflective display;

FIG. 5 illustrates an exploded view of a display device in accordance with an embodiment of the present invention;

FIG. 6 illustrates, in schematic form, a driver circuitry which may be used in conjunction with the display embodiment of FIG. 5;

FIG. 7 illustrates an exploded view of an alternative embodiment of a display device in accordance with the present invented principle;

FIG. 8 illustrates, in schematic form, an act of device which may be used in conjunction with the embodiment of FIG. 7;

FIGS. 9A-9C illustrates, in flow chart form, a field sequential color methodology in accordance with embodiments of the present invention;

FIG. 10 illustrates, in flow chart form, a methodology for manufacturing a liquid crystal display device in accordance with an embodiment of the present invention in which a metal oxide varistor as used as an active element;

FIG. 11 illustrates, in flow chart form, a process for manufacturing a liquid crystal display device in accordance with an alternative embodiment of the present invention in which a transistor is used as an active element;

FIG. 12 illustrates, in flow chart form, an alternative methodology for manufacturing a liquid crystal display using a transistor as an active element; and

FIG. 13 illustrates, in flow chart form, a method of manufacturing a liquid crystal display device in accordance with an alternative embodiment of the present invention

### DETAILED DESCRIPTION

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

Introduction

A field sequential flat panel display device and methods of manufacturing such devices are provided. Field sequential color (FSC) displays enables the display of color without the use of color filters, but rather through the use of fast switching liquid crystal material (or other optical material) in combination with fast switching light sources comprised of different colors. Rather than sub-pixels for spatial modulation of color, FSC displays use temporal multiplexing of colored light in one pixel to show color.

Scattering LCDs of the type made with localized volumes created either by the addition of polymer or other techniques, in combination with crossed-polarizers provide a direct view display device. Such devices have been described in U.S. Provisional Patent Application Ser. No. 60/388,237, entitled “Solid State Display”, filed on Jun. 13, 2002, and U.S. Provisional Patent Application Ser. No. 60/443,053, entitled “Solid State Display”, filed on Jan. 28, 2003, both of which are hereby incorporated herein by reference.

Displays using a scattering medium such as scattering LCDs, may in accordance with the present inventive principles include liquid crystal dispersion systems (LCDS) which represent one embodiment of a display device based on a light scattering medium to modulate the transmittance of the display to create a displayed image. Additionally, other embodiments of the present invention may use scattering media other than light scattering cells of the LCDS type. Each of theses classes of light scattering materials will be discussed further below. It would be appreciated by those of ordinary skill in the art that the present inventive principles may be practiced with any scattering medium exhibiting the required optical and switching characteristics imposed on display devices by the attributes of human perception, such a persistence of vision.

For the purposes herein, LCDS may be defined to encompass all light scattering liquid crystal systems whereby multiple surfaces are created in the cell; including as examples, but not limited to, the following systems: polymer dispersed liquid crystal (PDLC), reverse-mode PDLC (such as described in U.S. Pat. Nos. 5,056,898 and 5,270,843, and Internal-Reflection Inverted-Scattering (IRIS) Mode of Seiko-Epson Corp.), holographic PDLC (H-PDLC), nematic curvilinear aligned phase (NCAP), polymer network liquid crystal (PNLC), polymer encapsulated liquid crystal (PELC), polymer stabilized cholesteric texture (PSCT), phase separated composite film (PSCOF), colloidal templated liquid crystal composition such as the composition disclosed in U.S. Pub. No. 2001/0035918, which is hereby incorporated herein by reference, PMMA resin LC composition, and LC and macromolecular LC molecule compositions.

LCDS may also include LC mixtures including dispersed nanoparticles (such as silica made by Nanotechnology Inc., Austin, Tex. or Altair Nanotechnology, Reno, Nev.) which creates the necessary effect to enable light scattering by the LC molecules. The particles themselves are small and transparent.

LCDS may also include those LCDS made with channels, pockets or other cavities within the cell which have the same effect as polymer dispersion for scattering light. Examples of such techniques may be Plastic Pixels™ a product and process of Viztec, Inc., Cleveland, Ohio, Microcup LCD, a product and process by SiPix Imaging, Milpitas, Calif., (described in U.S. Pub. No. 2002/0126249 A1, which is hereby incorporated herein by reference) and PoLiCryst, as described by L. Vicari, J. Opt Soc. Am. B, Vol. 16 pp. 1135-1137 (1999), which is hereby incorporated herein by reference. Other techniques include filling open or connected micropores of a plastic sheet with a nematic or other type of liquid crystal (as disclosed in U.S. Pat. No. 4,048,358, which is hereby incorporated herein by reference). Such pores could be fabricated today for example with microreplication technologies employed by such companies as 3M, Minneapolis, Minn. and Avery Dennison, Pasadena, Calif. or for example utilizing the a pixilated foil platform such as that developed by Papyron B. V., The Netherlands.

Each of these systems would be recognized as being an LCDS by those of ordinary skill in the relevant art.

As noted above, embodiments of the present invention are not only limited to light scattering cells of the LCDS type, but also may include other light scattering liquid crystal materials such as chiral nematic liquid crystal or cholesteric liquid crystal which exhibits a light scattering mode in the focal conic state and a transparent state in the planar state. Also, smectic A liquid crystal is also known to scatter light in one state and change to a transparent state in another state. Cholesteric and smectic A liquid crystal do not require a polymer network or dispersion within a polymer matrix to create the scattering effect, but may be created with a polymer network.

Further, this invention is also applicable to non-liquid crystal materials which may be optically switched from a light scattering state to a substantially light transparent state. For example, small particulate matter may be suspended in a medium and behave in the same manner (scattering and non-scattering) as described herein. One such example of particulate matter suspended in a medium is Suspended Particle Device (SPD) light control technology developed by Research Frontiers, Inc., Woodbury, N.Y. This is only one of several types of non-liquid crystal electro-optical (switchable) light scattering materials which could be used in conjunction with the present inventive principles.

Note too, that light transmission may be improved by inducing a retardation effect within the cell. This may be caused by an appropriate preferred alignment of the droplets within the cell. This may be done by a combination of various techniques such as cell gap selection and manufacturing process parameters.

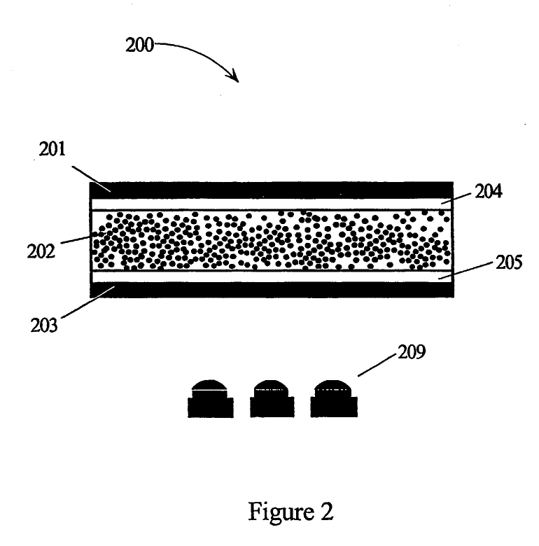

FIG. 2—Light Scattering Display Cell

FIG. 2 illustrates an embodiment of the present invention of a cell or pixel 200. (As described further below, a display may be fabricated from a plurality of cells 200. Cell 200 may include three layers including a top polarizer 201, a light scattering material 202 such as liquid crystal dispersion systems (LCDS) or other electro-optical scattering materials as previously discussed hereinabove. For example light scattering material may be a PDLC. Additionally, cell 200 may include a bottom polarizer 203. Top polarizer 201 may be coated with a substantially transparent conductive material 204 such as Indium-Tin-Oxide (ITO). Bottom polarizer 203 may be coated with a substantially transparent conductive material 205. In one embodiment, a plastic or polymer may hold polarizers 201, 203 eliminating glass or other substrates used in conventional displays.

Returning to light scattering material 202, in an embodiment of the present invention light scattering material 202 may be configured to capture nematic liquid crystal into very small droplets called “bubbles”. Once light scattering material 202 hardens, the bubbles are captured. Further, light scattering material 202 may be configured to harden to form a gas fight bond between polarizers 201, 203. A PDLC composition that may be used includes a commercially available liquid crystal BL035 available from Merck Specialty by Chemicals, Ltd. Poole, UK, dispersed in a ultraviolet (UV) curing epoxy M×M35 available from FFL Funktionsfluid GmbH, Mainz-Hechtsheim, Germany. For example, in one such composition that may be used the epoxy and liquid crystal may be in the ratio of about thirty percent (30%) epoxy to about seventy percent (70%) liquid crystal.

Further, light scattering material 202 may be configured to harden to form a bond between polarizers 201, 203. Moreover, by incorporating light scattering material 202 in cell 200, a liquid filling process as required in prior art LCD displays may no longer be required. And, by replacing LCD material with light scattering material 202, the critical vacuum seal around the edges may be eliminated.

FIG. 2 also depicts a light source, LEDs 209, to illustrate the use of cell 200 in a display configuration. LED's 209 may replace the flourescent light source used in conventional LCD displays, and eliminate the need for expensive color filters. Additionally, because LEDs may be switched in conjunction with the switching of electro-optical scattering material 202, a field sequential color display may be fabricated using a cell 200 in accordance with the present inventive principles. Additionally, such operation eliminates two-thirds of the number of data drivers that are otherwise needed in a conventional LCD display as the same driver may be used to exhibit all three colors (red, green and blue). Additionally, this increases the aperture-ratio of the pixel since cell 200 is not divided into red, green and blue sub-pixels as in a conventional LCD display. Additionally, the light source may be adjusted such that the light is collimated prior to transmittal through the cell. This would reduce leakage of light at wide viewing angles due to birefringent effects with incoming light from an angle within a liquid crystal material in the light scattering material.

In one embodiment, light scattering material may constitute a LCDS. It is noted that light scattering material may be any material capable of switching between a first state to a second state where in the first state, the light scattering material is substantially non-scattering in at least the operable portion of the light spectrum for which the display is to be used, and where in the second state the light scattering materials is substantially non-scattering in that portion of the spectrum. While it may typically be the case that the operable portion of the spectrum is the visible light spectrum, the present inventive principles may be used application in which at least one of the light sources is in the nonvisible portion of the spectrum. A night vision application, for example, may use an infrared light source. Additionally, the transition of the light scattering material between the first and second states (and vice versa) may be substantially continuous as a function of the voltage across the cell whereby an amount of light scattering also varies continuously. This is described further hereinbelow.

Contrast is achieved by the ratio of the maximum transmission—also referred to as the bright (optical ON) state—through the display compared to the dark (optical OFF) state. When the light scattering material is substantially transparent, the incoming polarized light from the backlight and first polarizer layer is unaffected, substantially blocked by the front polarizer and the optical OFF or dark state is achieved. When the light scattering material is in its most scattering bright (optical ON) state, the incoming polarized light is scattered, which effectively depolarizes the light enabling transmission through the front polarizer and the optical ON or bright state is achieved.

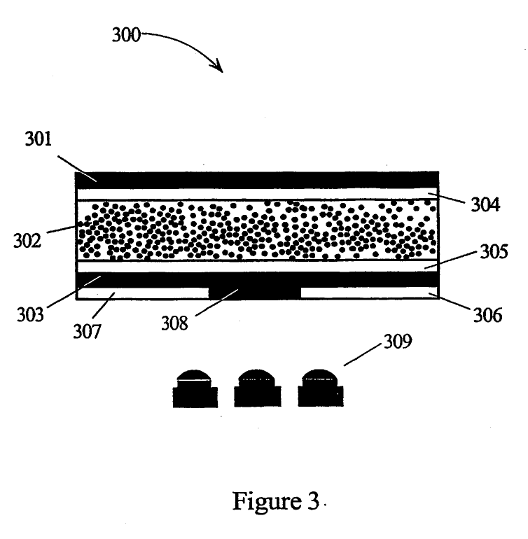

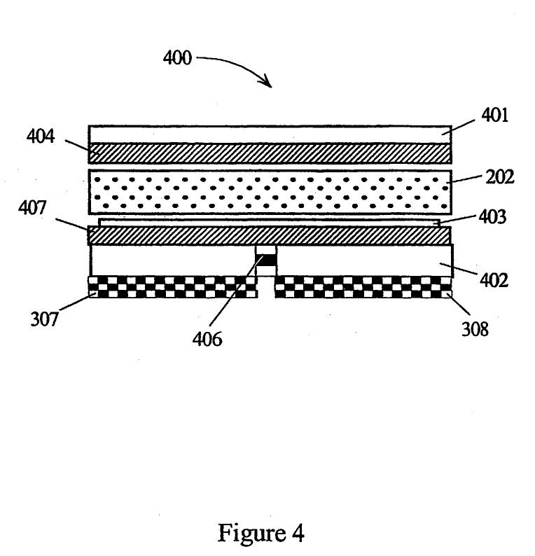

As previously noted, a display device may incorporate a plurality of cells 200. Such a display may include drive circuitry in conjunction with each cell to modulate the light transmittance of the cell by modulating the light scattering by the opto-electronic scattering medium FIG. 3 illustrates a cell 300, similar in configuration to cell 200 in FIG. 2 and further including drive circuitry associated therewith. Polarizers 301 and 303, conductive material 304 and 305, light scattering material 302 and light source 309 are respectively similar to polarizers 201, 203, conductive material 204 and 205, light scattering material 202 and light source 209 in FIG. 2. Drive electrodes include row select 306, and data line (or, equivalently, column select) 307. As described in further detail below, electrodes 306 and 307 are coupled to active element 308. An active element may include an amorphous silicon (a-Si) thin film transistor (TFT), a polysilicon TFT, TFT, a CdSe TFT or other switching device such as a metal-insulator-metal (MIM) diode, or a metal oxide varistor (MOV) as described in further detail hereinbelow. Electrodes 306, 307 may be bonded directly to polarizer 303 since a plastic or polymer may hold polarizer 303. Hence, the need for printed circuit boards (PCBs), printed wiring boards (PWBs) or tape automated bonding (TAB) may be eliminated. Further, since electrodes 306, 307 and active device 308 are located outside the cell gap, circuits 306, 307 may be configured to be thicker than in prior art thereby allowing very long thick but thin traces of the desired resistance. As illustrated in FIG. 3, active element 308 is placed inside the profile allowing more surface area while reducing the aspect ratio of cell 300 and permitting higher resolution pixel display densities. As further illustrated in FIG. 3, cell 300 does not place any components inside the critical cell gap (spacing between the top and bottom electrodes) as in conventional displays. By not having components inside the cell gap, cell 300 may be used to display materials such as supertwist nematic (STN), twisted nematic (1N), cholesteric, organic LED, electroluminescent (EL), electrophoretic ink (E-ink) and electrophoretic paper (E-paper). Another embodiment of a cell structure with more elements than cell 200 but easier to manufacture with off-the-shelf components is discussed below in conjunction with FIG. 4.

FIG. 4—Alternative Embodiment of Cell that Allows Construction of a Reflective Display Using Off-the-Shelf Components

FIG. 4 illustrates another embodiment of a cell 400 incorporating the principles of the present invention that allows construction of a reflective display using off-the-shelf components. Cell 400 is configured substantially the same as cell 300 (FIG. 3) except polarizers 301, 303 (FIG. 3) of cell 300 are replaced with polymer or glass substrates 401, 402. Substrates 401, 402 may each be coated with electrical conductive material (404, 407, respectively). In one embodiment, substrate 402 may not be transparent. Conductive material 404 may be transparent, e.g., ITO, and coating 407 may be a solid conductive paint or print Substrate 402 may be dimensioned to hold active component 406. Color element 403 may be added.

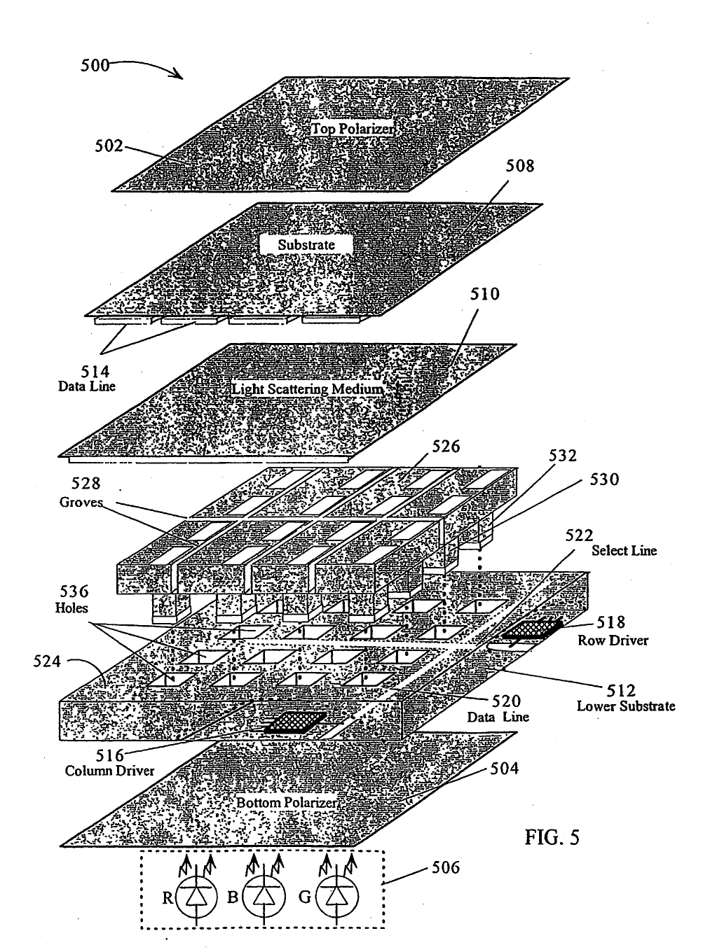

FIG. 5—Exploded Views

To further understand the configuration of display devices in accordance with embodiments of the present invention, refer now to FIG. 5 illustrating in exploded views, display devices 500-536, respectively.

FIG. 5 illustrating in an exploded view, an embodiment of a display device 500 in accordance with the present inventive principles. Display device 500 may be particularly adapted for use with a metal oxide varistor 530 (MOV) as the active device and a passive device 532 resistor. Display device 500 includes top and bottom polarizers, 502 and 504, respectively. An LED light source 506 including at least a tricolored set of LEDs (primary colors, red, green and blue) are disposed behind polarizer 504. Additionally a fourth, white LED may also be included in light source 506. (It would be appreciated by those of ordinary skill in the art that the depiction of light source 506 is schematic, and that an backlight embodiment would include a multiplicity of LED devices for each color. The operation of a backlight that may be used in conjunction with the present inventive principles will be discussed further hereinbelow.) An artisan of ordinary skill in the art would recognize that bottom polarizer may be omitted if a polarized light source is used. For example, laser diode sources may be used to provide a polarized source. Alternatively, a polarization mechanism may be integrated with the LEDs. One such device is the ProFlux Microwire™ polarizer supplied by Moxtek Inc., Orem, Utah. Note too that polarizer films need not be placed on the outside of the substrate. Alternatively the polarizers may be placed on the inner surface of the substrate, for example using thin crystal film (TCF™) polarizer technology as is available from Optiva, Inc., South San Francisco, Calif. Such placement may reduce parallax.

Disposed between the top and bottom polarizers are an upper substrate 508, opto-electronic light scattering medium 510 and a lower substrate 512. Upper substrate 508 may be glass in an embodiment of the present invention. Electrically conductive data lines 514 may be disposed on a bottom surface of upper substrate 508. Data lines 514 may be fabricated from ITO, for example, and the grooves therebetween formed by laser etching other etching methods scribing or printing. Lower substrate 512 provides a supporting structure for the electronic components of the display device. These may include row and column drivers 518 and 516, which are respectively coupled to select lines 522 and data lines 520, and mounted to the bottom surface of lower substrate 512. Data lines 520 may be electrically coupled to corresponding ones of data lines 514. Upper surface 524 of lower substrate 512 bears conductive coating 526, which is segmented by grooves 528. Grooves 528 segment conductive coating 526 to form the device cells, and constitute the lower electrodes thereof. Data lines 514 form upper electrodes of corresponding display cells. Display device 500 also includes drivers for each cell, which may comprise active driver members 530 and passive driver members 532. Active driver members 530 and passive driver members 532 may be disposed within corresponding holes 536 in substrate 512. Active driver members 530 may be MOV devices, and passive driver members 532 may be resistors. Active driver members 530 may be coupled to corresponding ones of select lines 522 and passive members may be coupled to corresponding ones of data lines 520.

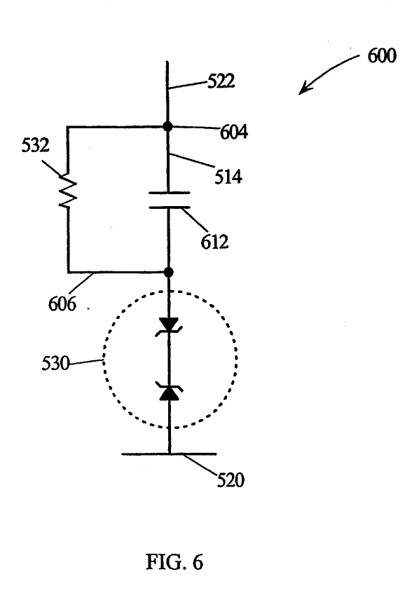

The interconnection of active members 530 and passive members 532 to form a driver may be further understood by referring to FIG. 6 illustrating a schematic representation of a driver 600 comprised of an active member 530 and passive member 532. Capacitor 602 represents the parasitic capacitance of a cell. Node 604 corresponds to the electrical interconnnection between data lines 520 and data lines 514 described hereinabove. Line 606 represents the electrical connection between passive member 532 and active member 530 formed by conductive coating 526.

In operation, the active member provides a threshold for the electro-optic scattering medium. To matrix address a device, the device remains inactive for at least one-half the applied voltage, Vₒₙ. For example, if the device is essentially fully on at the applied voltage Vₒₙ, it is desirable to be fully off at 0.5V on Volts. In other words, the data voltage on data 522 voltage is at 0.5Vₒₙ Volts, no other cell in the column can turn on unless the voltage across the cell is Vₒₙ Volts. To turn the cell on, the select or row voltage (on the corresponding select 520) has to go to a negative value, or −0.5Vₒₙ Volts. When the data voltage is at ground and the row voltage is at −0.5Vₒₙ Volts the cell should not turn on.

It would be appreciated by those of ordinary skill in the art that a MOV can be made to turn on at any desired voltage, primarily by changing the thickness, which sets the distance between the input and output electrodes. An embodiment of the present invention, the MOV may be selected to operate at the desired threshold For example, the MOV may be selected to have a turn-on voltage (commonly referred to as the MOV breakdown voltage) of about 5 volts. As shown in FIG. 5, active members 530 are shown to be located between the select electrodes and the bottom electrode of the cells. Alternatively the active members may be located between the top of the cell and the data electrodes.

The MOV active member also acts as a switch that will not let the cell discharge. This allows the cell to perform similarly to an active matrix device. Thus, the display does not depend on average voltage to operate. The result is that the display performance may be similar to active matrix displays.

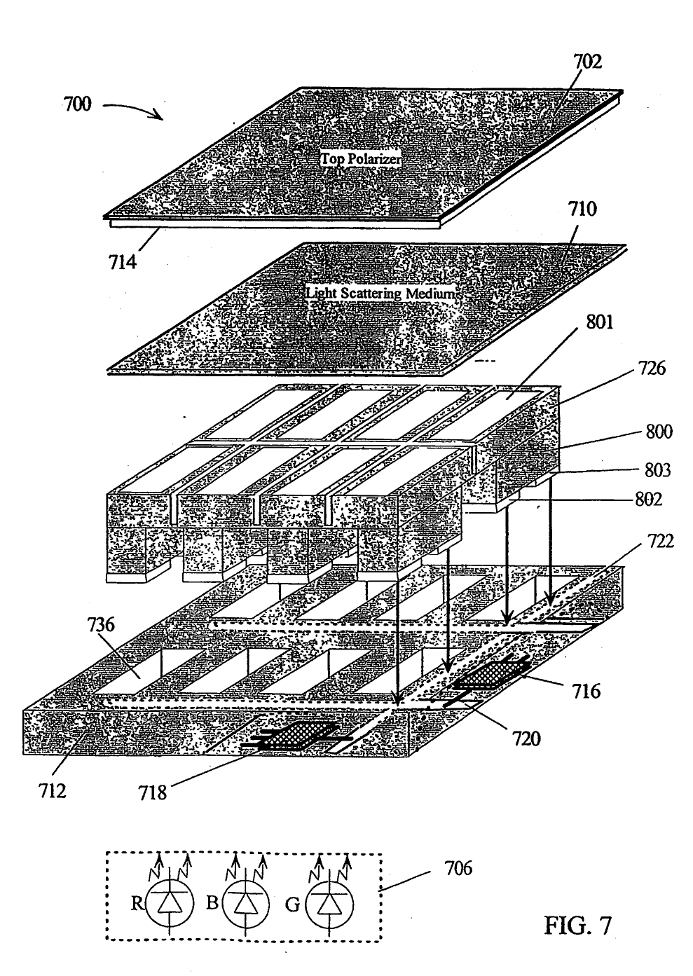

FIG. 7 illustrates an exploded view of another embodiment of a display device 700 in accordance with the principles of the present invention. Display device is similar to device 500 of FIG. 5 and includes top polarizer 702, opto-electronic light scattering medium 710 and a lower polarizer 712. Electrically conductive top electrode 714 may be disposed on a bottom surface of polarizer 702. Lower polarizer 712 may provide in the illustrated embodiment, a supporting structure for the electronic components of the display device which may include row and column drivers 716 and 718, which are respectively coupled to select lines 720 and data lines 722. Additionally, lower polarizer 712 may form a light channel for the light supplied by LED light source 706. In an alternative embodiment, a lower substrate, similar to lower substrate 512, FIG. 5, may be used in conjunction with a lower polarizer, similar to bottom polarizer 504, FIG. 5, or alternatively, a polarized light source.

LED light source 706 may include at least a tricolored set of LEDs (primary colors, red, green and blue). Alternatively, LED light source 706 may also have a white LED (not shown). The operation of display device 700 is similar to that of display device 500. An active element 800 mounted on polarizer 712 may be used as an alternative to active element 530 and passive element 532 shown in FIG. 5. Active element 800 uses only one hole 736 through polarizer 712.

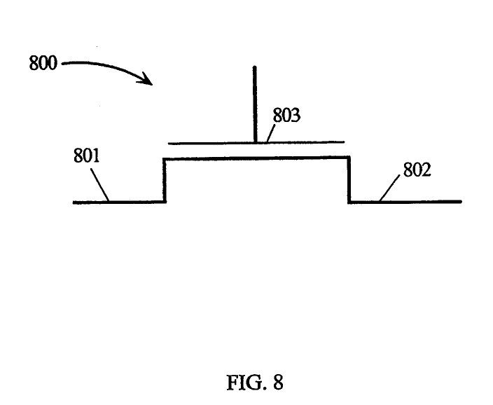

Referring to FIG. 8, active element 800 may be a TFT or similar device including a drain 801, source 802 and gate 803. The corresponding structures are also illustrated in FIG. 7.

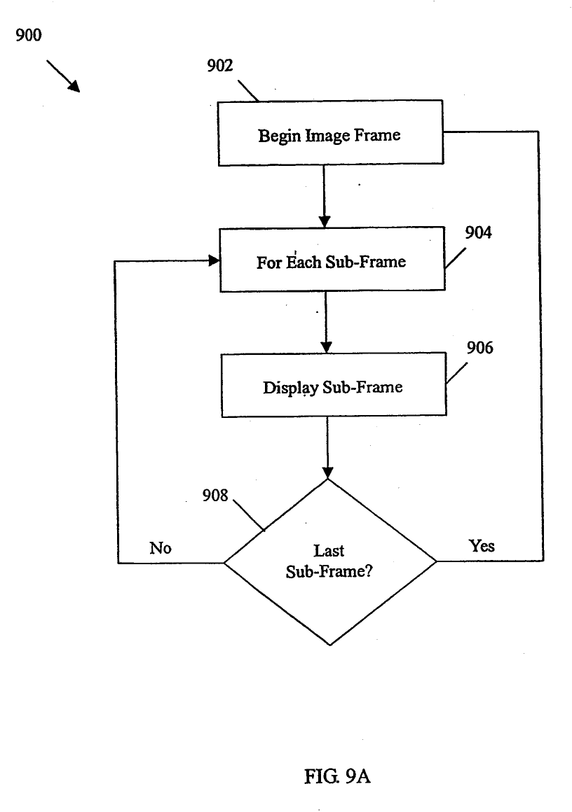

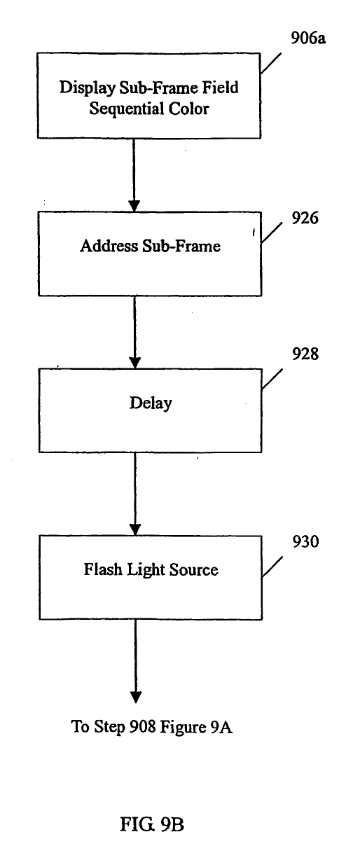

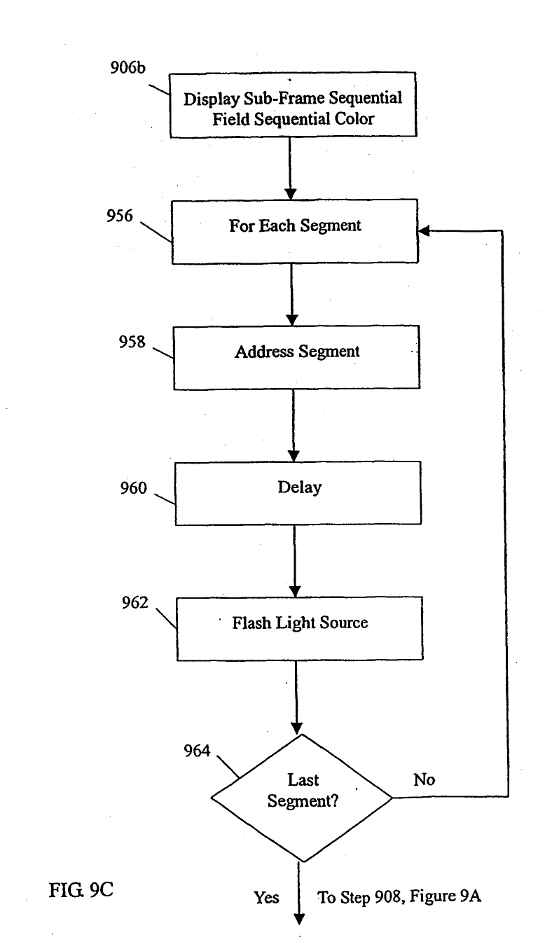

FIGS. 9A-9C—Operation of Field Sequential Color

The operation of a field sequential color display in accordance with the present invention may be further understood by referring to FIGS. 9A-9C. The generation of an image frame starts in step 902 of process 900 for generating a field sequential display in accordance with an embodiment of the present invention. Process 900 then enters a loop over sub-frames in step 904. For purposes herein, a sub-frame may be understood to be any portion of a complete frame of an image being rendered on the display; the complete frame being a composite of sub-frames. Commonly, field sequential color may be perceived to constitute the sequential display of three monochrome sub-frames in which all pixels of the display are addressed in each sub-frame. However, for the purposes herein, a sub-frame is not restricted to be monochromatic illumination, nor are the sub-frames necessarily three in number.

In step 906 the sub-frame is displayed. Step 906 will be described further in conjunction with FIGS. 9A and 9B (where, for clarity the alternative embodiments have been labeled 906a and 906b, respectively). If the current sub-frame is not the last sub-frame of the image frame, process 900 returns to step 904 to continue looping over sub-frames. Otherwise a new frame starts in step 902.

Refer now to FIG. 9B illustrating step 906 in further detail for a field sequential color methodology in accordance with an embodiment of the present invention.

In step 926, the sub-frame is addressed, whereby the illumination values are stored in the pixels (or equivalently cells) of the sub-frame.

In step 928 a delay may be employed. For example, a delay may be used to allow time for the light scattering material to reach a substantially stabilized state. Recall that electro-optic light scattering materials may be switched from a light scattering state to a substantially light transparent state and a continuum of light scattering states therebetween.

In step 930 the light source is flashed. The duration of the flash is determined by several factors, including but not limited to the sub-frame refresh rate, the addressing speed, the response of the display medium to a substantially stabilized state, and other human factors related issues. These factors are recognized to those skilled in the display art. And typical values may be in the range of about 1 to about 20 ms.

Step 906a then continues with step 908, FIG. 9A.

An alternative embodiment of a field sequential color display methodology in accordance with the present invention, which may be referred to a segmented field sequential color (SFSC) is illustrated in FIG. 9C (step 906b). Note that step 906a may be understood as a subset of step 906b in which a sub-frame comprises a single segment, or stated conversely, an SFSC having a single segment.

In step 956 loop over segments is entered.

In step 958, the pixels corresponding to a segment are addressed. As described further hereinbelow, a segment may include a preselected subset of pixels whereby the entire display constitutes the union of the segments. In other words, the addressing in step 956 may address a portion of the sub-frame.

In step 960 a delay may be employed. As previously noted, a delay may be used to allow time for the light scattering material to reach a substantially stabilized state. Recall that electro-optic light scattering materials may be switched from a light scattering state to a substantially light transparent state and a continuum of light scattering states therebetween.

In step 962, the light source is flashed. The duration of the flash is determined by several factors, including but not limited to the sub-frame refresh rate, the addressing speed, the response of the display medium to a substantially stabilized state, and other human factors related issues. These factors are recognized to those skilled in the display art. And typical values may be in the range of about 1 to about 20 Ms.

In accordance with the present inventive principles, a light source may be designed to be a segmented light source which may be used in conjunction with segmented addressing described in step 956. For example, in a typical three color (RGB) field sequential display, three light color sources are switched “OFF” while the specific color pattern is written to the entire sub-frame. Since a typical display operates at 60 Hz or 16.66 milliseconds this leaves approximately 5.5 milliseconds per sub-frame. This means that the display drivers must operate 3 times faster than normal. However, this does not leave any time to turn on the light sources. Therefore, it is desirable to write to the entire display in 1 millisecond, leaving 4.6 milliseconds to turn on the light source. This puts an even higher burden on the display driver circuits to run 16 times faster. By utilizing a segmented light source, the respective color light source remains “ON” for most of the time, approximately 5.5 milliseconds, and is only switched “OFF” during the time the drivers are writing to the pixels in the segmented sub-frame. If that segmented sub-frame constitutes 20 rows of a VGA display (640×480), as a further example, at 60 Hz frame rate this will be 16.66 ms/480/20 or 694.44 microseconds leaving 4.80 milliseconds for the light to be on. As discussed below, two benefits are apparent from this approach. First, the drivers can write at slower speeds. Second, the time the segmented image frame is illuminated is longer since the address time for a segmented sub-frame is less than the time required to address a complete sub-frame. This time difference is additional time the light source may stay flashed on for the segmented sub-frame.

To further appreciate SFSC, recall that steps 956-964 are inside the loop over sub-frames (step 904, FIG. 9A). Thus within each of the sub-frames, each segment is addressed, and therefore within each sub-frame, all pixels (or equivalently cells) are addressed. However, for each segment in successive frames, the color of the light source flashed in step 962 need not be the same. In other words, in the first frame, for a given segment, the color of the light source flashed in step 962 may be a first color, say red, for example. In the next frame, the color of the light source flashed in step 962 may be a second color, say green. Likewise, in the next frame the color of the light source flashed for the segment may be a third color, say blue, and so forth if the display includes more that three colors. Additionally, in the current frame, each segment in the loop over segments may sequence through the colors comprising the light source.

To further understand an SFSC process in accordance with the present inventive principles, consider the following concrete example which further illustrates the previous discussion of a segmented light source. As stated above, a display in accordance with the present invention may be divided into segments each composed of n select lines or rows of pixels. For illustration suppose n is five. At typical frame rates of about 120 Hz-190 Hz each segment may be written in 1.1 milliseconds. For an XGA of 1024 columns X 1024 rows, each segment would be composed of 1024/5 or approximately 205 lines or rows.

To operate a conventional field sequential color (FSC), the entire 1024 lines need to be written in less than 3 milliseconds, leaving only 2.5 milliseconds for the backlight to add color. This implies a writing speed of about 2.9 microseconds per line or row.

In the SFSC process of the present invention, the segment is written in 1 millisecond leaving 4.5 milliseconds for the light source to add color, implying a writing speed 4.8 microseconds per row. The result is slower writing speed (4.8 us) for SFSC than for FSC (2.9 us). Because the time the segment is on is longer a slower responding LCD or scattering material may be used.

Additionally because for the reason that sub-frame contains one-third of the full color image frame (for a three-color system) and it is harder for the eye to see changes in the image as the extra one-third is added each sub-frame. The result is that human eye sees less flicker and the sub-frame rate may be reduced from for example 120 Hz to about 25-30 Hz.

One of ordinary skill in the art would appreciate that the foregoing values are illustrative and other frame rates, resolutions, number of colors, etc. would give rise to different values and all such embodiments would fall within the spirit and scope of the present invention.

Step 906b then continues with step 908, FIG. 9A.

Although the method and display device are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims. It is noted that the headings are used only for organizational purposes and not meant to limit the scope of the description or claims.

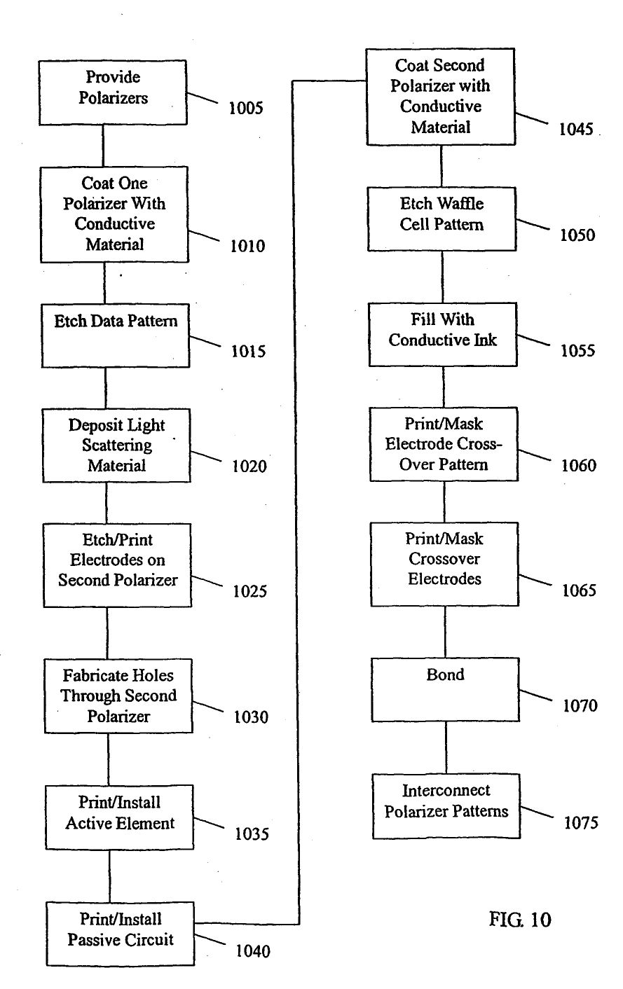

FIG. 10—Method of Manufacturing Display with MOV Active Elements

A method of manufacturing a liquid crystal device in accordance with the current invention, using a metal oxide varistor (MOV) as the active element, is shown in FIG. 10. In step 1005, top and bottom polarizers are provided, such as 502 and 504 in FIG. 3. These polarizers have interior and exterior surfaces. The interior of the top polarizer is coated with a conductive material, such as ITO, in step 1010. A data pattern is then etched into that conductive coating in step 1015. A light scattering material is then deposited in step 1020.

Drive electrodes and cell data and source electrodes are etched or printed onto the exterior surface of the bottom polarizer in step 1025. In step 1030, sets of first and second holes are fabricated through the bottom polarizer. In step 1035, metal oxide varistor active elements are then printed or installed into the first holes through the bottom polarizer so that one electrode of the active element is resident to the interior surface of the polarizer, but not pertruding past the plane of the interior surface. In step 1040, passive elements are printed or installed into the second holes through the bottom polarizer so that they are congruent to but not protruding past the plane of the interior surface of the bottom polarizer. The interior of the bottom polarizer is coated with a conductive medium in step 1045. This conductive medium, shown as 526 in FIG. 5, will make an electrical contact between the active and passive electrical elements. In step 1050, a cell pattern is etched in the conductive material deposited in step 1045.

Step 1055 involves filling the electrode pattern on the exterior surface of the bottom polarizer with conductive ink, provided that this was not previously printed in step 1025. At the intersection of the data and source electrodes printed in step 1025, a crossover electrode pattern is printed or masked on the exterior of the bottom polarizer in step 1060. Subsequently, in step 1065, crossover electrodes are printed or masked on to the exterior surface of the bottom polarizer. The top and bottom polarizer assemblies are then bonded together in step 1070 and the data pattern on the top polarizer is interconnected with the data electrode pattern on the bottom polarizer in step 1075.

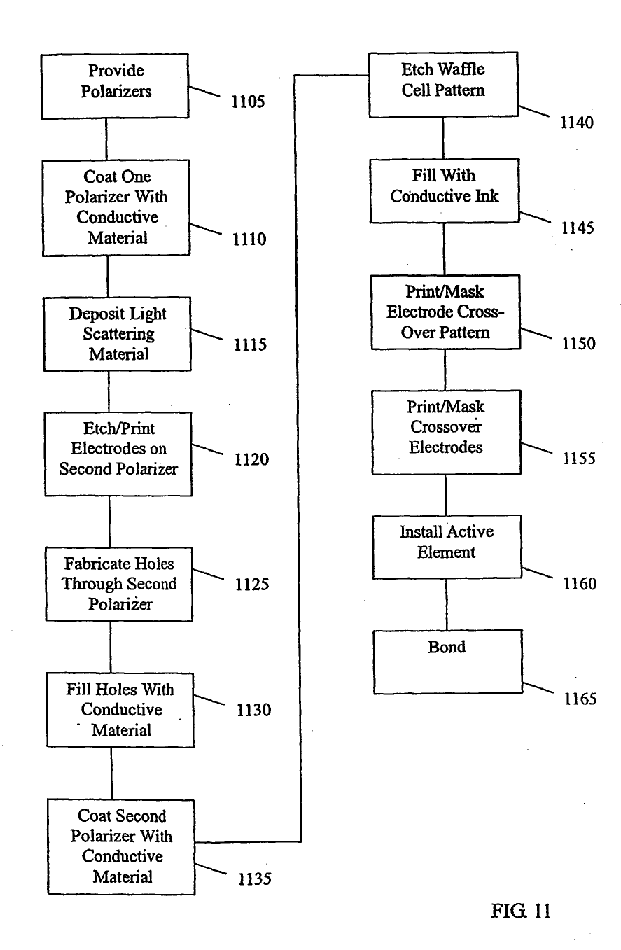

FIG. 11—Method for Manufacturing Display with Transistor Active Elements

An alternative method for manufacturing a liquid crystal device of the present invention, using a transistors as the active element, is shown in FIG. 11. Top and bottom polarizers are provided in the step 1105. These polarizers also comprise the top and bottom substrates and have surfaces both interior to and exterior to the cell. The interior of the top polarizer is coated with a conductive material, such as ITO, in step 1110. A light scattering medium 510 is then deposited onto the coated interior surface of the top polarizer in step 1115.

Driver electrodes and cell and data source electrodes are etched or printed onto the exterior surface of the bottom polarizer 504 in step 1120. In step 1125, holes are fabricated through the bottom polarizer, which are then filled with a conductive material in step 1130. This conductive material forms an electrical conduit between the interior and exterior surfaces of the bottom polarizer. The interior of the bottom polarizer is coated with a conductive medium in step 1135, which makes an electrical contact with the conductive material filled into the holes in step 1125. A cell pattern is then etched into the conductive material coated on in 1135, if not previously printed in that step.

The electrode pattern on the exterior of the bottom polarizer is then filled with conductive ink in step 1145, if this has not previously been done as part of step 1120. An electrode crossover pattern is printed or masked onto the exterior of the bottom polarizer at the intersection of the data source electrodes, in step 1150 and then crossover electrodes are printed or masked on in step 1155. In step 1160, the active element transistors are installed to make electrical connections between the row and data electrodes and the electrical conduits through the polarizer; this includes connections between data and drain, gate and row, and source to conduit. The two polarizer assemblies are then bonded to one another in step 1165.

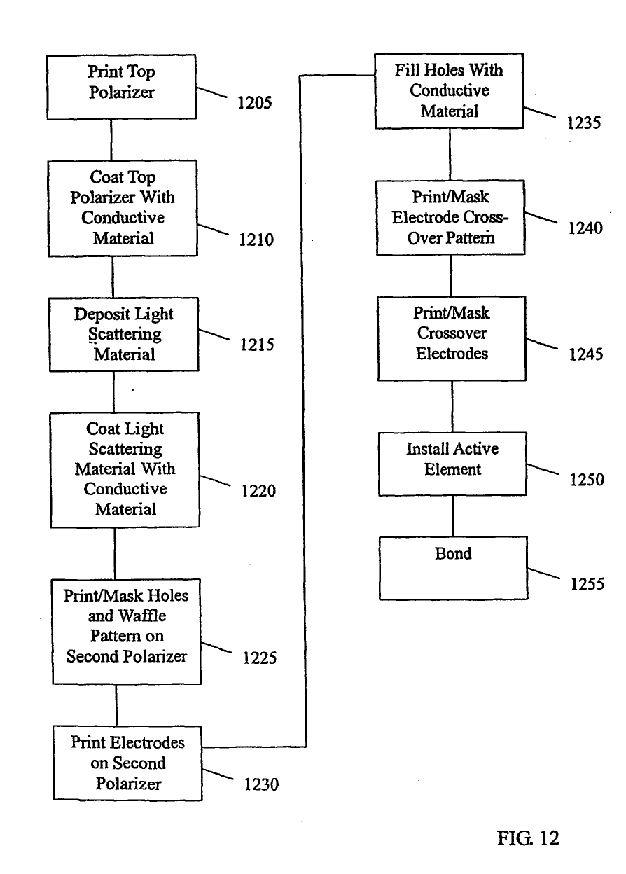

FIG. 12—Method of Manufacturing Display Using Transistor Active Element by Printing

Another alternative method of manufacturing a display device according to the present invention, using transistors as the active element, is shown in FIG. 12. In step 1205, a top polarizer is printed onto the exterior surface of a substrate. The interior of that substrate is coated with a conductive material, such as ITO, in step 1210. Light scattering material is deposited onto the conductive material in step 1215. The light scattering material is then coated with a conductive material layer, such as ITO, in step 1220.

In step 1225, a bottom substrate is then provided, onto which the bottom polarizer is printed, holes are masked or printed for pass-through conductors and a waffle pattern is printed 1225. Driver electrodes and cell data and source electrodes are printed onto the exterior surface of the bottom polarizer in step 1230. The holes through the bottom substrate are then filled with conductive material, in step 1235, thus forming an electrical conduit between the interior and exterior surfaces. An electrode crossover pattern is then printed or masked onto the exterior surface of the bottom substrate in step 1240, and then crossover electrodes are then printed or masked onto that substrate in step 1245. Active element transistors are then installed in step 1250, to make electrical connections among the row and data electrodes and electrical conduits; this includes connections between drain and data, gate and row, and source to conduit The top and bottom substrate/polarizer assemblies are then bonded to one another in step 1255.

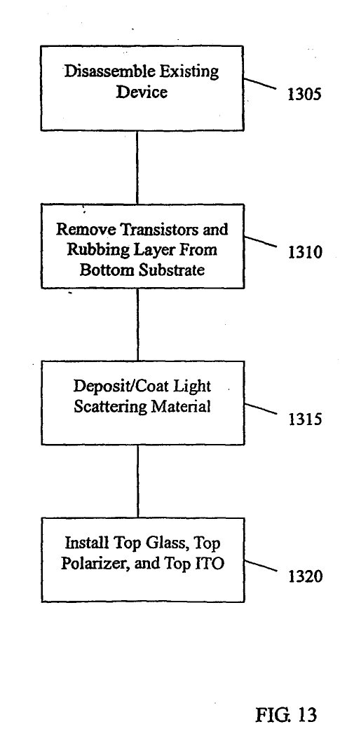

FIG. 13—Method of Modifying an Existing Display

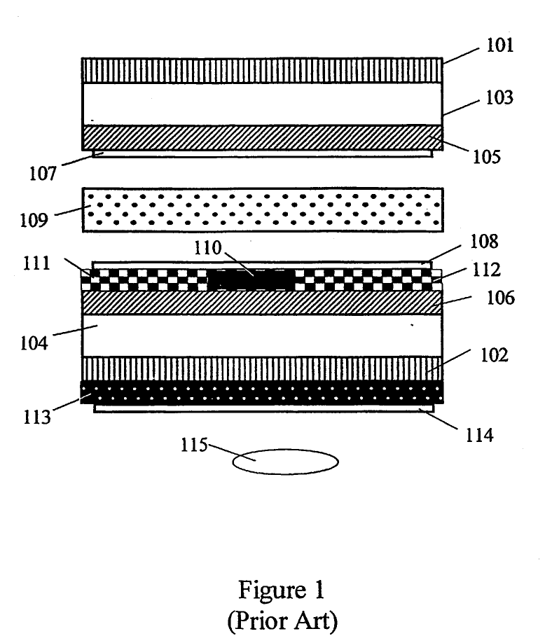

It is also contemplated that one might wish to modify an existing liquid crystal display to conform with the present invention. FIG. 13 discloses a method for modifying existing liquid crystal display devices. In step 1305, the existing LCD is disassembled by removing the top substrate assembly, including the polarizer, the conductive (ITO) layer, rubbing layer and color filter (described in FIG. 1). Up to two-thirds of the transistors are removed from the bottom substrate assembly, along with, optionally, the rubbing layer on that substrate, in step 1310. Light scattering material is then coated onto the interior surface of the bottom substrate, in step 1315. The top substrate assembly is then reinstalled including only the polarizer, the substrate itself, and the conductive (ITO) layer, and optionally the rubbing layer, in step 1320.

1. A display device comprising:
a polarizer; and
a light scattering material disposed in a transmission path between said polarizer and a polarized light source, wherein said light scattering material is switchable from a first state to a second state in response to an applied electrical field, wherein said light source includes a plurality of independently controllable colors.

2. The display device as recited in claim 1, wherein said light scattering material comprises a Polymer Dispersed Liquid Crystal (PDLC).

3. The display device as recited in claim 1 further comprising:
a substantially transparent conductive layer disposed between said polarizer and said light scattering material.

4. The display device as recited in claim 3, wherein said substantially transparent conductive layer is disposed on said polarizer.

5. The display device as recited in claim 3, wherein said substantially transparent conductive layer is an Indium-Tin Oxide (ITO) layer.

6. The display device as recited in claim 1, wherein in said first state, said light scattering material is substantially non-scattering, wherein in said second state, said light scattering material is substantially scattering.

7. The display device as recited in claim 1, wherein said light scattering material comprises a nematic curvilinear aligned phase (NCAP) polymer dispersed liquid crystal system.

8. A display device comprising:
a first and second polarizer;
a light scattering material disposed between said first and second polarizer; and
a light source having a plurality of colors, wherein portions of said light scattering material are operable for selectable excitation, wherein an excitation of a portion of said light scattering material is operable for controlling an amount of light of a color of said plurality of colors emitted by said display device.

9. The display device as recited in claim 8 further comprises:
a first and second substantially transparent conductive layers disposed between each of said first and second polarizer, wherein said excitation of said portion of said light scattering material layer comprises an electric field applied between a corresponding portion of said first and second substantially transparent conductive layers.

10. The display device as recited in claim 8, wherein said first polarizer forms a substrate, wherein the liquid crystal display device further comprises a driver circuit mounted on said substrate.

11. The display device as recited in claim 8, wherein said second polarizer forms a substrate, wherein the display device further comprises an active element embedded in said substrate.

12. The display device as recited in claim 11 wherein said active device is a varistor.

13. The display device as recited in claim 8, wherein said light scattering material comprises polymer dispersed liquid crystal.

14. A method for manufacturing a display device comprising the steps of:
providing a first and a second polarizer, wherein each of said first and second polarizer comprises a first and a second layer;
coating said second layer of said first polarizer with conductive material; and
depositing a light scattering material layer between said first and second polarizer.

15. The method as recited in claim 14 further comprising the steps of:
making holes through said second polarizer; and
forming a driver and electrodes on said second layer of said second polarizer.

16-30. (canceled)

31. The method as recited in claim 14 wherein said second polarizer comprises a third layer, wherein the method further comprises the step of:
printing an active element on said third layer of said second polarizer.

31. The method as recited in claim 15, wherein said second polarizer comprises a third layer, wherein the method further comprises the step of:
printing an active element on said third layer of said second polarizer.

32. The method as recited in claim 14 further comprising the steps of:
coating said first layer of said second polarizer with conductive material; and
etching a cell pattern on said first layer of said second polarizer.

33. The method as recited in claim 15 further comprising the steps of:
coating said first layer of said second polarizer with conductive material; and
etching a cell pattern on said first layer of said second polarizer.

34. The method as recited in claim 31 further comprising the steps of:
coating said first layer of said second polarizer with conductive material; and
etching a cell pattern on said first layer of said second polarizer.

35. The method as recited in claim 14 further comprising the steps of:
printing a crossover insulation pattern on said first layer of said second polarizer; and
printing a crossover electrode pattern on said first layer of said second polarizer.

36. The method as recited in claim 15 further comprising the steps of:
printing a crossover insulation pattern on said first layer of said second polarizer; and
printing a crossover electrode pattern on said first layer of said second polarizer.

37. The method as recited in claim 31 further comprising the steps of:
printing a crossover insulation pattern on said first layer of said second polarizer; and
printing a crossover electrode pattern on said first layer of said second polarizer.

38. The method as recited in claim 32 further comprising the steps of:
printing a crossover insulation pattern on said first layer of said second polarizer; and
printing a crossover electrode pattern on said first layer of said second polarizer.

39. The method as recited in claim 14, wherein said light scattering material comprises polymer dispersed liquid crystal.

40. A display device comprising:
a polarizer; and
a light scattering material disposed on a surface of said polarizer.

41. The display device of claim 40 wherein said light scattering material is positioned to receive polarized light.

42. The display device of claim 41 further comprising a light source including a plurality of independently controllable colors, said light source operable to source said polarized light.

43. The display device of claim 41 further comprising a second polarizer positioned between said light scattering material and a light source having a plurality of independently controllable colors.

44. A method of displaying an image frame comprising:
(a) addressing a sub-frame segment; and
(b) flashing a light source, wherein said light source comprises a plurality of independently controlled portions, and wherein said sub-frame comprises a one or more of said sub-frame segments, said independently controlled portions corresponding to said sub-frame segments, and wherein said image frame comprises a composite of a plurality of sub-frames.

45. The method of claim 44 further comprising:
(c) repeating steps (a) and (b) for each segment of said sub-frame.

46. The method of claim 45 further comprising repeating step (c) for each sub-frame of said composite.

47. The method of claim 44 wherein said each of said independently controlled segments comprise a first color for a first sub-frame of said image frame and a second color for a second sub-frame of said composite.

48. The method of claim 45 wherein said each of said independently controlled segments comprise a first color for a first sub-frame of said image frame and a second color for a second sub-frame of said composite.

49. The method of claim 46 wherein said each of said independently controlled segments comprise a first color for a first sub-frame of said image frame and a second color for a second sub-frame of said composite.

50. The method of claim 44 wherein said segment comprises a full sub-frame.

51. A method for modifying an existing liquid crystal display device that includes a top and bottom substrate assembly, wherein said top substrate assembly includes a polarizer, substrate, conductive layer, and said bottom substrate assembly includes a plurality of transistors, comprising the steps of:
removing the top substrate assembly;
removing up to two-thirds of the transistors from the bottom substrate assembly;
disposing a light scattering material upon interior surface of the bottom substrate assembly;
installing top substrate assembly polarizer, substrate, and conductive layer upon bottom substrate assembly.

52. The method as recited in claim 51 wherein the bottom substrate assembly includes a rubbing layer, the method further comprising the step of:
removing the rubbing layer from the bottom substrate assembly.
